(19) United States
(12) Patent Application Publication
(10) Pub. No.: US 2019/0272962 A1
(43) Pub. Date: Sep. 5, 2019

(54) OPTIMIZED HYBRID SUPERCAPACITOR

(71) Applicant: Robert Bosch GmbH, Stuttgart (DE)

(72) Inventors: Elisabeth Buehler, Tamm (DE); Mathias Widmaier, Magstadt (DE); Pallavi Verma, Echterdingen (DE); Parviz Hajiyev, Grenoble (FR); Severin Hahn, Kirchheim Unter Teck (DE); Lars Bommer, Leonberg (DE)

(21) Appl. No.: 16/343,894

(22) PCT Filed: Oct. 11, 2017
(86) PCT No.: PCT/EP2017/075900

§ 371 Date: Apr. 22, 2019

(30) Foreign Application Priority Data
Oct. 27, 2016 (DE) 10 2016 221 172.2

(51) Int. Cl. H01G 11/38; H01G 11/04; H01G 11/46

(52) U.S. Cl. CPC H01G 11/38; H01G 11/50; H01G 11/46; H01G 11/04

(57) ABSTRACT

A hybrid supercapacitor includes positive and negative electrodes each having the following composition: 1-5% by mass of a binder; 2.5-7.5% by mass of a conductive additive; and 87.5-96.5% by mass of an active material, where the active material of the positive electrode is a mixture of (a) 30-40% by mass LiMn₂O₄ (LMO) and (b) 60-70% by mass activated carbon, and the active material of the negative electrode is a mixture of (a) 20-30% by mass Li₄Ti₅O₁₂ (LTO) and (b) 70-80% by mass activated carbon, and where the ratio of the active mass of the negative electrode to that of the positive electrode is in a range of 0.4-1.2.

### CROSS-REFERENCE TO RELATED APPLICATIONS

The present application is the national stage of International Pat. App. No. PCT/EP2017/075900 filed Oct. 11, 2017, and claims priority under 35 U.S.C. § 119 to DE 10 2016 221 172.2, filed in the Federal Republic of Germany on Oct. 27, 2016, the content of each of which are incorporated herein by reference in their entireties.

### FIELD OF THE INVENTION

The present invention relates to a hybrid supercapacitor.

### BACKGROUND

Storage of electrical energy using electrochemical energy storage systems such as electrochemical capacitors (supercapacitors) or electrochemical primary or secondary batteries has been known for many years. These energy storage systems differ in their underlying principle of energy storage.

Supercapacitors generally include a negative electrode and a positive electrode that are separated from each other by a separator. In addition, an ion-conductive electrolyte is situated between the electrodes. The storage of electrical energy is based on the fact that when a voltage is applied to the electrodes of the supercapacitor, an electrochemical double layer forms on the surfaces of the electrodes. This double layer is formed from solvated charge carriers from the electrolyte, which become arranged on the surfaces of the oppositely electrically charged electrodes. In this type of energy storage, a redox reaction is not involved. Theoretically, supercapacitors can therefore be charged as often as desired, and thus have a very long service life. In addition, the power density of the supercapacitors is high, whereas the energy density is rather low compared to lithium-ion batteries, for example.

In contrast, the energy storage in primary and secondary batteries takes place via a redox reaction. These batteries also generally include a negative electrode and a positive electrode that are separated from each other by a separator. An ion-conductive electrolyte is likewise situated between the electrodes. In lithium-ion batteries, one of the most commonly used secondary battery types, the energy storage takes place via the intercalation of lithium ions into the electrode active materials. During operation of the battery cell, i.e., during a discharging operation, electrons flow in an external circuit from the negative electrode to the positive electrode. During a discharging operation, lithium ions migrate from the negative electrode to the positive electrode within the battery cell. In the process, the lithium ions are reversibly deintercalated from the active material of the negative electrode, also referred to as delithiation. During a charging operation of the battery cell, the lithium ions migrate from the positive electrode to the negative electrode. In the process, the lithium ions are reversibly reintercalated into the active material of the negative electrode, also referred to as lithiation.

Lithium-ion batteries are characterized in that they have a high energy density, i.e., they are able to store a large quantity of energy per mass or volume. However, in return they have only a limited power density and service life. This is disadvantageous for many applications, so that lithium-ion batteries cannot be used, or can be used only to a limited extent, in these areas.

Hybrid supercapacitors represent a combination of these technologies, and are suitable for closing the gap between the application options in lithium ion battery technology and supercapacitor technology.

Hybrid supercapacitors generally likewise include two electrodes, which each includes a current collector, and which are separated from each other by a separator. The transport of the electrical charges between the electrodes is ensured by electrolytes or electrolyte compositions. As active material, the electrodes generally include a conventional supercapacitor material (also referred to below as statically capacitive active material) and a material that is capable of entering into a redox reaction with the charge carriers of the electrolyte and forming an intercalation compound therefrom (also referred to below as electrochemical redox active material). The energy storage principle of the hybrid supercapacitors is thus based on the formation of an electrochemical double layer in combination with the formation of a Faraday lithium intercalation compound.

The energy storage system thus obtained has a high energy density, and at the same time, a high power density and a long service life.

Hybrid supercapacitors also include further components such as separators, collectors, and a housing. The collectors are used for the electrical contacting of the electrode material, and connect it to the terminals of the capacitor. The collectors must have good conductivity. To prevent corrosion, the collectors and the housing are generally made of the same material, usually aluminum.

The energy density and power density of a hybrid supercapacitor are determined by the electrode active materials used. The electrochemical redox active material used allows a high energy density, whereas the statically capacitive active material determines the power density. The overall capacity of the negative or positive electrode largely determines the potential limits of the two electrodes in a charged cell. For this reason, the capacity of the positive electrode must be precisely matched to the capacity of the negative electrode (or vice versa). An incorrect design of the electrode capacity can result in a greatly reduced service life of the cell since, for example, an excessively high capacity of the negative electrode results in an excessive increase in the potential of the positive electrode (in a charged cell). The positive electrode can thus be “forced” into an unstable potential range, which can result in secondary reactions (electrolyte decomposition, for example). The overall capacity of an individual electrode of a hybrid supercapacitor is primarily determined by four factors:

i) electrode active materials used;

ii) mixing ratio of statically capacitive active material to electrochemical redox active material;

iii) total fraction of the active materials in the electrode; and

iv) total mass of the electrode.

This results in complex relationships for the composition of the individual electrodes.

Cericola et al., Journal of Power Sources 2011, 196, pp. 10305-10313, describe a hybrid supercapacitor having an electrode composition of 80% by mass active material, 5% by mass graphite and 5% by mass carbon black as conductive additives, and 10% by mass of a polymeric binder (PTFE). The active material of the positive electrode contains 28% by mass LiMn₂O₄ (LMO) and 72% by mass activated carbon. The active material of the negative electrode contains 19% by mass Li₄Ti₅O₁₂ (LTO) and 81% by mass activated carbon.

### SUMMARY

The present invention relates to a hybrid supercapacitor that includes electrodes having the following composition:
1-5% by mass of a binder,
2.5-7.5% by mass of a conductive additive, and
87.5-96.5% by mass of an active material, where the active material of the positive electrode is a mixture of (a) 30-40% by mass LiMn₂O₄ (LMO) and (b) 60-70% by mass activated carbon; and the active material of a negative electrode is a mixture of (a) 20-30% by mass Li₄Ti₅O₁₂ (LTO) and (b) 70-80% by mass activated carbon.

The ratio of the active mass of the negative electrode to that of the positive electrode is in a range of 0.4-1.2.

An underlying finding of the present invention is that a surprising increase in the power density can also be achieved as capacity when the stated components for manufacturing the electrodes are combined in the stated mass fractions. It has thus been shown in test series that compliance with these strict specifications results in an increase in the energy density by up to 20% to 49 WW/kg, and an increase in the power density by up to 70% to 36 kW/kg, compared to a hybrid supercapacitor as described by Cericola et al.

According to an example embodiment variant of the hybrid supercapacitor, the active material of the positive electrode is a mixture of a) 33-37% by mass LiMn₂O₄ (LMO) and b) 63 to 67% by mass activated carbon. Notwithstanding, a preferred combination for the active material of the negative electrode is preferably a mixture of a) 23-27% by mass Li₄Ti₅O₁₂ (LTO) and b) 73-77% by mass activated carbon. The ratio of the active mass of the negative electrode to that of the positive electrode is preferably in a range of 0.6-1.0. The energy density and power density can be further increased by specifying the narrower content parameters for the components of the active material of the positive and/or negative electrodes.

The active material of the positive electrode is very particularly preferably a mixture of a) 35% by mass LiMn₂O₄ (LMO) and b) 65% by mass activated carbon. Notwithstanding, a very particularly preferred combination of the active material of the negative electrode is a mixture of a) 24.1% by mass Li₄Ti₅O₁₂ (LTO) and b) 75.9% by mass activated carbon. The ratio of the active mass of the negative electrode to that of the positive electrode is very particularly preferably in a range of 0.7-0.9. It has been experimentally shown that the combination of the stated compositions of the active material of the two electrodes represents an optimum for the power density, energy density, and service life.

In addition, the following composition of the electrodes is preferred:
89-92% by mass of the active material,
4-6% by mass of the conductive additive, and
4-5% by mass of the binder.

In particular, the electrodes have the following composition: 90% by mass active material, 5% by mass conductive additive, and 5% by mass binder. The content of active material is accordingly significantly higher compared to a conventional hybrid supercapacitor.

It has also proven to be particularly advantageous when the conductive additive is only carbon black. Thus, it has been experimentally shown that the use of only this conductive additive, compared to a combination of graphite and carbon black, positively affects the energy density as well as the power density. For the above-described hybrid supercapacitor that is optimized with regard to the composition of the active materials of the electrodes, this measure has resulted, for example, in a further increase in the power density by 2%, and in the energy density by 7%.

The hybrid supercapacitor according to the present invention thus includes at least one positive electrode and at least one negative electrode. The electrodes are each in contact with an electrically conducting current collector, also referred to as a collector. The active material can be applied directly to the collector, so that the electrode is present in the form of a coating on the collector. The current collector can be formed from copper or aluminum, for example. In an example embodiment, the current collector of the positive electrode and the negative electrode is made of aluminum.

The negative active material can be applied to the collector of the negative electrode as a coating. In the present case, the negative active material includes an electrochemical redox active material, namely, Li₄Ti₅O₁₂ (LTO). In addition, the negative active material contains activated carbon. The two components are present in the narrowly defined mass ratio described above.

The positive active material can be applied to the collector of the positive electrode as a coating. The positive active material includes a statically capacitive active material, namely, activated carbon, and an electrochemical redox active material, namely, LiMn₂O₄ (LMO). The two components are present in the narrowly defined mass ratio described above.

As further components, the negative active material and the positive active material can include one or multiple binders such as styrene-butadiene copolymer (SBR), polyvinylidene fluoride (PVDF), polytetrafluoroethene (PTFE), carboxymethylcellulose (CMC), polyacrylic acid (PAA), polyvinyl alcohol (PVA), and ethylene propylene diene terpolymer (EPDM) in order to increase the stability of the electrodes.

A separator is situated between the positive electrode and the negative electrode. The separator is used to protect the electrodes from direct contact with each other, thus preventing a short circuit. At the same time, the separator ensure the transfer of the ions from one electrode to the other.

Suitable materials are characterized in that they are formed from an electrically insulating material having a porous structure. Suitable materials are in particular polymers such as cellulose, polyolefins, polyesters, and fluorinated polymers. Particularly preferred polymers are cellulose, polyethylene (PE), polypropylene (PP), polyethylene terephthalate (PET), polytetrafluoroethene (PTFE), and polyvinylidene fluoride (PVDF). In addition, the separator can include or be made of ceramic materials, provided that a substantial (lithium) ion transfer is ensured. Ceramics that include MgO or Al₂O₃ are examples. The separator can be made of a layer of one or more of the materials mentioned above, or also of multiple layers in which in each case one or more of the mentioned materials are combined with each other.

In addition, the hybrid supercapacitor contains an electrolyte that includes at least one aprotic, organic solvent that is liquid under the conditions that typically prevail in electrochemical energy storage systems during operation.

Suitable solvents have sufficient polarity for dissolving the further components of the electrolyte composition, in particular the conducting salt or the conducting salts. Tetrahydrofuran, diethyl carbonate, or y-butyrolactone, as well as cyclic and acyclic carbonates, in particular acetonitrile, propylene carbonate, ethylene carbonate, dimethyl carbonate, diethyl carbonate, ethylene methyl carbonate, ethyl methyl carbonate, and mixtures thereof are examples. Acetonitrile, propylene carbonate, ethylene carbonate, dimethyl carbonate, diethyl carbonate, ethylene methyl carbonate, ethyl methyl carbonate, and mixtures thereof are particularly preferred.

In addition, the electrolyte composition includes at least one conducting salt. Salts with sterically sophisticated anions and optionally sterically sophisticated cations are particularly suited. Examples of such are tetraalkylammonium borates such as N(CH₃)₄BF₄. However, in particular, lithium salts are one particularly suitable class of conducting salts. The conducting salt can be selected, for example, from the group made up of lithium chlorate (LiClO₄), lithium tetrafluoroborate (LiBF₄), lithium hexafluorophosphate (LiPF₆), lithium hexafluoroarsenate (LiAsF₆), lithium trifluoromethanesulfonate (LiSO₃CF₃), lithium bis(trifluoromethylsulfonyl) imide (LiN(SO₂CF₃)₂), lithium bis(pentafluoroethylsulfonyl) imide (LiN(SO₂C₂F₅)₂), lithium bis(oxalato) borate (LiBOB, LiB(C₂O₄)₂), lithium difluoro(oxalato) borate (LiBF₂(C₂O₄)), lithium tris(pentafluoroethyl) trifluorophosphate (LiPF₃(C₂F₅)₃), and combinations thereof.

The electrolyte can also optionally contain additives that, for example, improve the wettability, increase the viscosity, or provide overcharge protection.

Advantageous refinements of the present invention can be inferred from the description. Example embodiments of the present invention are explained in greater detail with reference to the drawings and the following description.

### BRIEF DESCRIPTION OF THE DRAWINGS

FIG. 1 schematically shows a basic design of a hybrid supercapacitor according to an example embodiment of the present invention.

FIG. 2 shows, in a Ragone diagram, a performance of two hybrid supercapacitors according to example embodiments of the present invention compared to a conventional hybrid supercapacitor.

### DETAILED DESCRIPTION

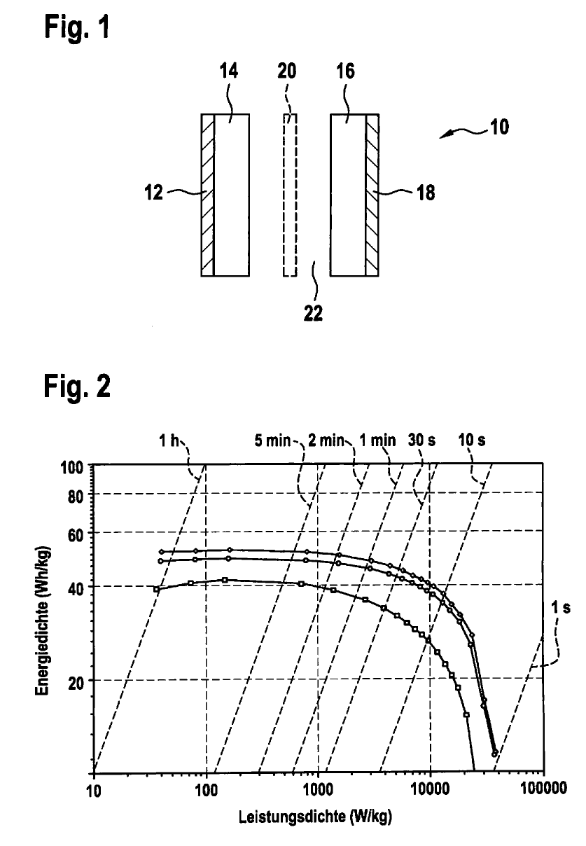

FIG. 1 schematically shows a basic design of a hybrid supercapacitor 10. A flat collector 12 contacts a negative electrode 14 and connects it to the outer terminals (not illustrated). Situated opposite from same is a positive electrode 16, which likewise is conductively connected to a collector 18 for discharging to the outer terminals. The two electrodes 14, 16 are separated by a separator 20. Conductive electrolyte 22 establishes an ion-conductive connection between the two electrodes 14, 16.

### EXAMPLE EMBODIMENT 1

For manufacturing positive electrode 16, a mixture of 2.475 g LMO and 4.596 g activated carbon as active material (ratio: 35% by mass LMO and 65% by mass activated carbon) and 0.4 g carbon black and 0.4 g graphite as conductive additive is prepared. This mixture is dry-mixed in a mixer at 1000 rpm for 10 min. 20 mL isopropanol is then added, and the resulting suspension is initially stirred at 2500 rpm for 2 min, then treated with ultrasound for 5 min, and subsequently stirred at 2500 rpm for an additional 4 min. 0.8 g polytetrafluoroethylene suspension (60% in water) as binder is then added to the mixture, and stirring is continued at 800 rpm for an additional 5 min until the mixture has a paste-like consistency. The paste is rolled on a glass plate to form a positive electrode approximately 150 μm thick, and is subsequently applied to a collector (carbon-coated aluminum foil).

For manufacturing negative electrode 14, initially a mixture of 1.704 g LTO and 5.367 g activated carbon as active material (ratio: 24.1% by mass LTO and 75.9% by mass activated carbon) and 0.4 g carbon black as conductive additive is prepared. This mixture is dry-mixed in a mixer at 1000 rpm for 10 min. 20 mL isopropanol is then added, and the resulting suspension is initially stirred at 2500 rpm for 2 min, then treated with ultrasound for 5 min, and subsequently stirred at 2500 rpm for an additional 4 min. 0.8 g polytetrafluoroethylene suspension (60% in water) as binder is then added to the mixture, and stirring is continued at 800 rpm for an additional 5 min until the mixture has a paste-like consistency. The paste is rolled on a glass plate to form a negative electrode approximately 150 μm thick, and is subsequently applied to a collector (aluminum foil).

Separator 20 is manufactured based on cellulose. Electrolyte 22 contains a lithium salt such as LiClO₄ and an aprotic solvent such as acetonitrile; electrolyte 22 also contains one or multiple additive(s).

### EXAMPLE EMBODIMENT 2

The same procedure is followed as for example embodiment 1, except that 0.81 g carbon black is used instead of the combination of carbon black and graphite as the conductive additive for the two electrodes.

### COMPARATIVE EXAMPLE

The same procedure is followed as for example embodiment 1, except that a) for manufacturing the positive electrode, a mixture of LMO and activated carbon is prepared in which the two components are present in a ratio of 28% by mass LMO to 72% by mass activated carbon, and b) for manufacturing the negative electrode, a mixture of LTO and activated carbon is prepared in which the two components are present in a ratio of 19% by mass LTO to 81% by mass activated carbon.

The specific power is plotted as a function of the specific energy in a Ragone diagram to allow easier comparison of different hybrid supercapacitors. FIG. 2 shows corresponding curves for the two hybrid supercapacitors according to the present invention from example embodiments 1 and 2, as well as the conventional hybrid supercapacitor according to the comparative example. As is apparent, the composition according to example embodiment 1 (middle curve with circular points) has a significantly higher energy density and power density than the comparative example (bottom curve with rectangular points). When only carbon black is used as the conductive additive, a further increase can be achieved, as is apparent from the curve for example embodiment 2 (top curve with diamond-shaped points).

1-8. (canceled)

9. A hybrid supercapacitor comprising:
a positive electrode; and
a negative electrode;
wherein:
a composition of the positive electrode is:
1-5% by mass of a binder;
2.5-7.5% by mass of a conductive additive; and
87.5-96.5% by mass of an active material that is a mixture of (a) 30-40% by mass LiMn₂O₄ (LMO) and (b) 60-70% by mass activated carbon;
a composition of the negative electrode is:
1-5% by mass of a binder;
2.5-7.5% by mass of a conductive additive; and
87.5-96.5% by mass of an active material that is a mixture of (a) 20-30% by mass Li₄Ti₅O₁₂ (LTO) and (b) 70-80% by mass activated carbon; and
a ratio of active mass of the negative electrode to active mass of the positive electrode is in a range of 0.4-1.2

10. The hybrid supercapacitor of claim 9, wherein:
the mixture of the active material of the positive electrode is (a) 33-37% by mass LMO and (b) 63-67% by mass activated carbon; and
the ratio of the active mass of the negative electrode to the active mass of the positive electrode is in a range of 0.6-1.0.

11. The hybrid supercapacitor of claim 10, wherein the mixture of the active material of the negative electrode is (a) 23-27% by mass LTO and (b) 73-77% by mass activated carbon.

12. The hybrid supercapacitor of claim 9, wherein:
the mixture of the active material of the negative electrode is (a) 23-27% by mass LTO and (b) 73-77% by mass activated carbon; and
the ratio of the active mass of the negative electrode to the active mass of the positive electrode is in a range of 0.6-1.0.

13. The hybrid supercapacitor of claim 9, wherein:
the mixture of the active material of the positive electrode is (a) 35% by mass LMO and (b) 65% by mass activated carbon; and
the ratio of the active mass of the negative electrode to the active mass of the positive electrode is in a range of 0.7-0.9.

14. The hybrid supercapacitor of claim 13, wherein the mixture of the active material of the negative electrode is (a) 24.1% by mass LTO and (b) 75.9% by mass activated carbon.

15. The hybrid supercapacitor of claim 9, wherein:
the mixture of the active material of the negative electrode is (a) 24.1% by mass LTO and (b) 75.9% by mass activated carbon; and
the ratio of the active mass of the negative electrode to the active mass of the positive electrode is in a range of 0.7-0.9.

16. The hybrid supercapacitor of claim 9, wherein the binder of each of the positive and negative electrodes is a polymeric binder, and each of the positive and negative electrodes have the composition of:
89-92% by mass of the respective electrode's active material;
4-6% by mass of the respective electrode's conductive additive; and
4-5% by mass of the respective electrode's polymeric binder.

17. The hybrid supercapacitor of claim 9, wherein the binder of each of the positive and negative electrodes is a polymeric binder, and each of the positive and negative electrodes have the composition of:
90% by mass of the respective electrode's active material;
5% by mass of the respective electrode's conductive additive; and
5% by mass of the respective electrode's polymeric binder.

18. The hybrid supercapacitor of claim 9, wherein the conductive additive is carbon black.

19. The hybrid supercapacitor of claim 9, wherein the binder is a polymeric binder.

20. The hybrid supercapacitor of claim 19, wherein the polymeric binder is polytetrafluoroethylene (PTFE).

21. The hybrid supercapacitor of claim 19, wherein the polymeric binder is a mixture of SBR and CMC.

22. The hybrid supercapacitor of claim 9, further comprising an electrolyte.

23. The hybrid supercapacitor of claim 22, wherein the electrolyte includes at least one liquid, aprotic organic solvent.

24. The hybrid supercapacitor of claim 23, wherein the at least one liquid, aprotic organic solvent is selected from acetonitrile, propylene carbonate, ethylene carbonate, dimethyl carbonate, diethyl carbonate, ethylene methyl carbonate, ethyl methyl carbonate, and mixtures thereof.
